(19) United States
(12) Patent Application Publication
(10) Pub. No.: US 2015/0363803 A1
(43) Pub. Date: Dec. 17, 2015

(54) BUSINESS INTRODUCTION INTERFACE

(71) Applicant: BIZINTRO, LLC, Manhattan, IL (US)

(72) Inventor: Steven Thomas, Manhattan, IL (US)

(21) Appl. No.: 14/742,569

(22) Filed: Jun. 17, 2015

Related U.S. Application Data
(60) Provisional application No. 62/013,207, filed on Jun. 17, 2014.

(51) Int. Cl. G06Q 30/02; G06F 3/0484; G06F 3/0482; G06Q 50/00

(52) U.S. Cl. CPC G06Q 30/0204; G06Q 50/01; G06F 3/04842; G06F 3/04847; G06F 3/0482

(57) ABSTRACT

Methods for searching within one's social network for business leads and the presentation and facilitation of introduction requests associated therewith are provided. In particular, a user may log into a website to search their social network based on introduction parameters. In response, a set of introducers who can connect the user to individuals matching the introduction parameters are provided and stored. Subsequently, an indication is presented to each introducer such that each introducer is made aware that the user is requesting an introduction to someone within the respective introducer's network. Upon viewing the indication, the introducer may select an individual matching the introduction parameters and transmit to that individual an introduction request.

### CROSS REFERENCE TO RELATED APPLICATIONS

This application claims benefit of the filing date of U.S. Provisional Patent Application 62/013,207, filed Jun. 17, 2014, and entitled “Business Introduction Interface.” The contents of U.S. Provisional Patent Application 62/013,207 are expressly incorporated herein by reference in its entirety.

### TECHNICAL FIELD

The present disclosure generally relates to a method for facilitating effective business introductions and, more particularly, to a method for organizing, filtering, aggregating, and cross-referencing business contact information for effective business interactions.

### BACKGROUND

Professional networking and other social media websites are currently gaining exposure and prominence in the life of business professionals. For example, many business professionals use such sites to maintain a list of professional contacts, endorse or recommend colleagues, search for jobs, etc. These sites can be advantageous in growing a business and building a valuable network of professional connections.

However, the data generated and displayed by professional networking sites is often overwhelming to users in that users are presented with large lists of their many immediate contacts, even larger lists of close contacts (e.g., people to whom they are connected via immediate contacts), and a vast range of parameters (e.g., job function, location, etc.) associated with contacts. If, for example, a business professional would like to reach out to sales leads, the business professional can spend a significant amount of time searching for high potential leads, writing messages to those leads, keeping track of sent messages/responses, etc. Moreover, due to a lack of intuitive design, cohesiveness, and efficiency, potential business leads are often reluctant to spend time on a site responding to business introductions or messages from unknown individuals.

### BRIEF SUMMARY

In an aspect, a computer-implemented method is provided. The method comprises (1) receiving, via one or more processors, introduction parameters from a user of a website, wherein the introduction parameters comprise keywords describing a type of person to which the user would like to be introduced; (2) analyzing, by the one or more processors, business contacts corresponding to the user to identify a set of introducers, wherein the set of introducers comprises a subset of the business contacts having their own respective business contacts matching the introduction parameters; (3) storing, by the one or more processors, the introduction request, wherein storing the introduction request comprises storing the introduction parameters and the set of introducers; and (4) presenting, by the one or more processors, an indication of the introduction parameters to each of the set of introducers. The method may include additional, fewer, or alternative steps, includes discussed elsewhere herein.

In another aspect, another computer-implemented method is provided. The method comprises (1) displaying, on a graphical user interface (GUI), an indication that a user has received a plurality of introduction requests; (2) receiving, via the GUI, a selection of a specific introduction request from the plurality of introduction requests; (3) presenting, on the GUI, a message interface, wherein the message interface enables the user to generate an introduction message to a business contact in accordance with the specific introduction request; and (4) sending, via one or more processors, the introduction message to the business contact. The method may include additional, fewer, or alternative steps, includes discussed elsewhere herein.

### BRIEF DESCRIPTION OF THE DRAWINGS

FIG. 1 illustrates an example computing environment for managing effective business introductions;

FIG. 2 is a block diagram of an example implementation of the business introduction server illustrated in FIG. 1;

FIGS. 3A and 3B are example web pages in which a user may upload, retrieve, or generate data about business contacts;

FIG. 4 is a flow diagram of an example method for requesting business introductions, which can be implemented in the environment illustrated in FIG. 1;

FIGS. 5A and 5B are example web pages which may be utilized as part of the method of FIG. 4;

FIG. 6 is a flow diagram of an example method for making business introductions, which can be implemented in the environment illustrated in FIG. 1;

FIGS. 7A and 7B are example web pages which may be utilized as part of the method of FIG. 6;

FIG. 8 is an example web page with a navigation window;

FIG. 9 is an example web page with a notification window;

FIG. 10 is an example web page with a calendar interface; and

FIG. 11 is an example web page with a messaging interface.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such terms should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

It should be appreciated that the present invention solves a problem inherent in modern social networks; namely, the inability to meaningfully process the large volumes of information associated with a user's contacts across all of the social networks with which the user interacts. The amount of information is so overwhelming, that users are often unaware of the existence of a potential leads that may assist users in the furtherance of their careers. To this end, the present methods solve this problem by compiling all of a user's contacts into an easily searchable database that can readily expose meaningful relations within the user's social networks. Said another way, the present methods can be described as reducing social network congestion. As a result, the conventional diverse and overwhelming sequence of interactions with social networks is overridden by the present streamlined methods of social network interactions.

Similarly, the provided methods improve a technology, namely, social networking. Instead of the methods merely being performed by hardware components using basic functions, the methods employ complex steps that go beyond the mere concept of simply retrieving and combining data using a computer. In particular, the hardware components compile all of a user's business contacts into a searchable database, reconcile any conflicting contact information, determine whether any business contacts match a search query, generate graphical user interfaces to facilitate user interaction, and communicate introduction requests and introduction messages to appropriate parties, among other functionalities. This combination of elements impose meaningful limits in that the operations are applied to improve social networking by improving the consolidation and analysis of one's contacts across all of their social networks, and by targeting the communication of introduction requests in a meaningful and effective way.

### System Overview

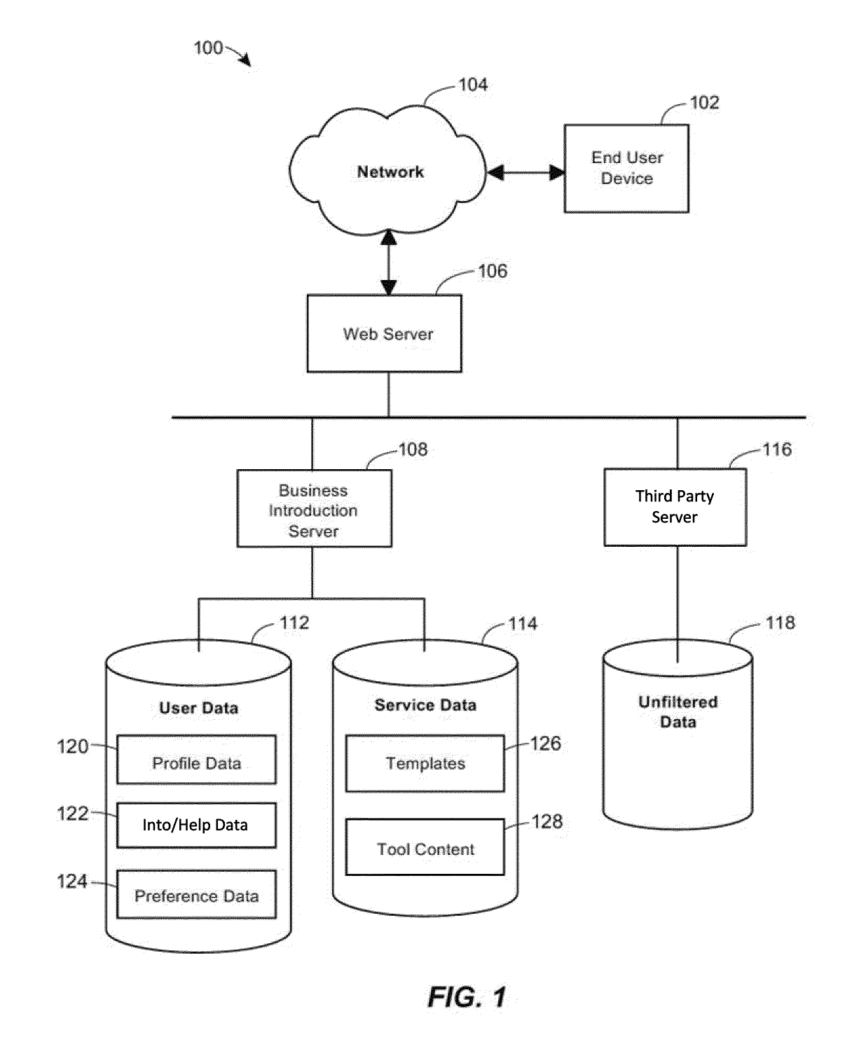

FIG. 1 illustrates an example computing environment 100 to manage and facilitate effective business introductions based on retrieved and filtered business contact data. A user of an end user device 102 is communicatively coupled, via one or more wired or wireless interfaces, to a network 104 and a web server 106. The end user device may include any suitable computing device such as a personal computer, smartphone, tablet computer, etc. The network 104 may be a proprietary network, a secure public internet, a virtual private network or some other type of network, such as dedicated access lines, plain ordinary telephone lines, satellite links, combinations of these, etc. Where the network 104 comprises the Internet, data communications may take place over the network 104 via an Internet communication protocol.

The web server 106 may be implemented in one of several known configurations via one or more servers configured to process web-based traffic received via the network 104 and may include load balancing, edge caching, proxy services, authentication services, etc.

In an implementation, the end user device 102 is capable of executing a graphical interface (GUI) for a business introduction interface/tool within a web browser application, such as Apple's Safari®, Google Android™ mobile web browser, Microsoft Internet Explorer®, etc. The web browser application may be implemented as a series of machine-readable instructions for receiving, interpreting, and displaying web page information from the web server 106 while also receiving inputs from the user. Further, those skilled in the art will recognize that the present system can be used in a dedicated application in addition to a web browser. Further, certain functionality of the business introduction interfaces/tools discussed herein may be implemented as plug-ins, bookmarklets, add-ons, social/professional network “apps,” or other software components that operate in cooperation with locally or remotely executed web browser, or other, applications.

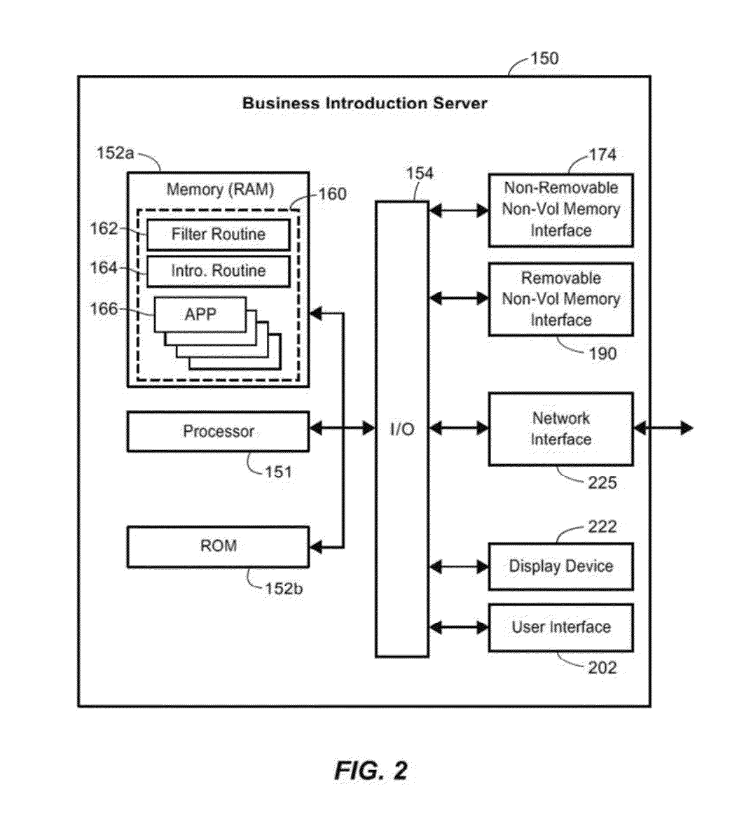

A business introduction server 108 may include a number of software applications responsible for generating content for the web pages or other interfaces of the business introduction interfaces discussed herein. The content may be included in web pages sent from the web server 106 to the end user device 102. For example, the business introduction server 108 may generate filtered contact lists, message interfaces, forms, tables, etc. as discussed below, to be included in the web pages sent to the end user device 102. The details of an implementation of the business introduction server 108 are discussed in more detail with reference with FIG. 2. Further, although FIG. 1 illustrates one business introduction server 108, the techniques of the present disclosure may be implemented by any number of servers with any number of processors, such as in a “cloud computing” implementation.

In some implementations, the business introduction server 108 is operatively connected to a user database 112 and a service database 114. However, it should be noted that, while not shown, additional database may be operatively connected to the business introduction server 108 and/or the databases 112 and 114 may be combined into a single database or data structure. Further, the business introduction server 108 and/or end user device 102 may be communicatively coupled to data generated by a third party server 116 and stored in an unfiltered database 118, in an implementation. For example, the third party server 116 may generate content for a professional networking, or social media, tool to be included in the web pages sent from the web server 106 to the end user device 102. Further, the third party server 116 may receive, track, and update data (e.g., stored in the unfiltered database 118) about business professionals subscribed to the professional networking tool, connections between business professionals (e.g., connected through certain individuals, connected by location, etc.), etc., in an implementation. In other implementations, the third party server 116 may receive and organize contact and/or calendar data corresponding to a user of the end user device 102, as further discussed below.

The user database 112 may be, for example, configured to store: (i) a plurality of profile data 120 corresponding to users of the business introduction tool (e.g., usernames, passwords, business contacts, payment information, etc.); (ii) a plurality of introduction/help data 122 corresponding to prior and/or current requests for business introductions generated by certain users or generated to be displayed to certain users; and (iii) a plurality of preference data 124 corresponding to certain users and representing saved calendar, time zone, payment, email template, etc. preferences for use in the business introduction tool. The service database 114 may be, for example, configured to store: (i) a plurality of templates 126 for sending messages between business contacts, where the plurality of templates 126 may be optionally modified by the plurality of preference data 124; and (ii) a plurality of tool content 128 for generating content to be included in the web pages sent from the web server 106 to the end user device 102.

FIG. 2 illustrates an example business introduction server 150 that may manage business introductions and generate business introduction interface content for display on an end user device. The business introduction server 150 may be implemented as the business introduction server 108 in the example computing system 100, for example. The business introduction server 150 may include one or more processing units, 151, a system memory, 152a and 152b, and a system bus 154 that couples various system components including the system memory 152 to the processing units 151. The system bus 154 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The business introduction server 150 may include an assortment of computer-readable media. Computer-readable media may be any media that may be accessed by the business introduction server 150. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory may include storage media in the form of volatile and/or non-volatile memory such as ROM 152a and RAM 152b. A basic input/output system (BIOS), containing algorithms to transfer information between components within the computer 150, may be stored in ROM 152b. Data or program modules that are immediately accessible or are presently in use by the processing units 151 may be stored in RAM 152a. Data normally stored in RAM 152a while the business introduction server 150 is in operation may include an operating system, application programs, program modules, and program data. In particular, the RAM 152a may store a business introduction tool program 160 including a filter routine 162, introduction routine 164, and various other applications 166 (e.g., calendar application, spreadsheet application, etc.) integrated into the business introduction tool program 160, for example.

The business introduction server 150 may also include other storage media such as a hard disk drive that may read from or write to non-removable, non-volatile magnetic media, a magnetic disk drive that reads from or writes to a removable, non-volatile magnetic disk, and an optical disk drive that reads from or writes to a removable, nonvolatile optical disk. Other storage media that may be used includes magnetic tape cassettes, flash memory cards, digital versatile disks, digital video tape, solid state RAM, and solid state ROM. The hard disk drive may be connected to the system bus 154 through a non-removable memory interface such as interface 174. A magnetic disk drive and optical disk drive may be connected to the system bus 154 by a removable memory interface, such as interface 190.

A user may interact with the business introduction server 150 through input devices such as a keyboard or a pointing device (i.e., a mouse). A user input interface 202 may be coupled to the system bus 154 to allow the input devices to communicate with the processing units 151. A display device 222, such as a monitor, may also be connected to the system bus 154 via a video interface (not shown).

The business introduction server 150 may operate in a networked environment using logical connections to one or more remote computing devices, such as end user device 102, web server 106, or cost estimation server 125, for example. The remote computing device may be a personal computer (PC), a server, a router, or other common network node. The remote computing device typically includes many or all of the previously-described elements regarding the business introduction server 150, even though such elements are not illustrated in the remote computing devices of FIG. 1. Logical connections between the business introduction server 150 and one or more remote computing devices may include a wide area network (WAN). A typical WAN is the Internet. When used in a WAN, the business introduction server 150 may include a modem or other means for establishing communications over the WAN. The modem may be connected to the system bus 154 via the network interface 225, or other mechanism. In a networked environment, program modules depicted relative to the business introduction server 150, may be stored in the remote memory storage device. As may be appreciated, other means of establishing a communications link between the computer 150 and a remote computing device may be used.

### Retrieving, Aggregating, and Cross-Referencing Business Contacts

In some implementations, a user of the end user device 102 may interact with web pages presented to the user (via a web browser application) so as to retrieve, upload, and store indications of business contacts in the user database 112, or other suitable computer-readable storage medium accessible by the business introduction server 108. Generally, the business contacts may correspond to any individuals acquainted with, professionally associated with, or otherwise connected to the user of the end user device 102.

The business introduction server 108 may store records corresponding to each of the business contacts retrieved or uploaded by a user of the end user device 102. For example, the user database 112 may include a database of business contacts including names, addresses, phone numbers, email addresses, titles, employers, etc. of the business contacts. However, in other implementations, the business introduction server 108 may only store indications of or links to third party or other databases storing this sort of information about the business contacts. For example, the user database 112 may store authentication information (usernames and passwords), hyperlinks, etc. such that the business introduction server 108 may easily interact with data about business contacts stored in a remote database, where the database is not administered by or managed by the business introduction server 108. The remote database may, for example, include databases associated with email addresses, social media accounts, professional networking accounts, customer relationship management accounts, etc. of the user of the end user device 102.

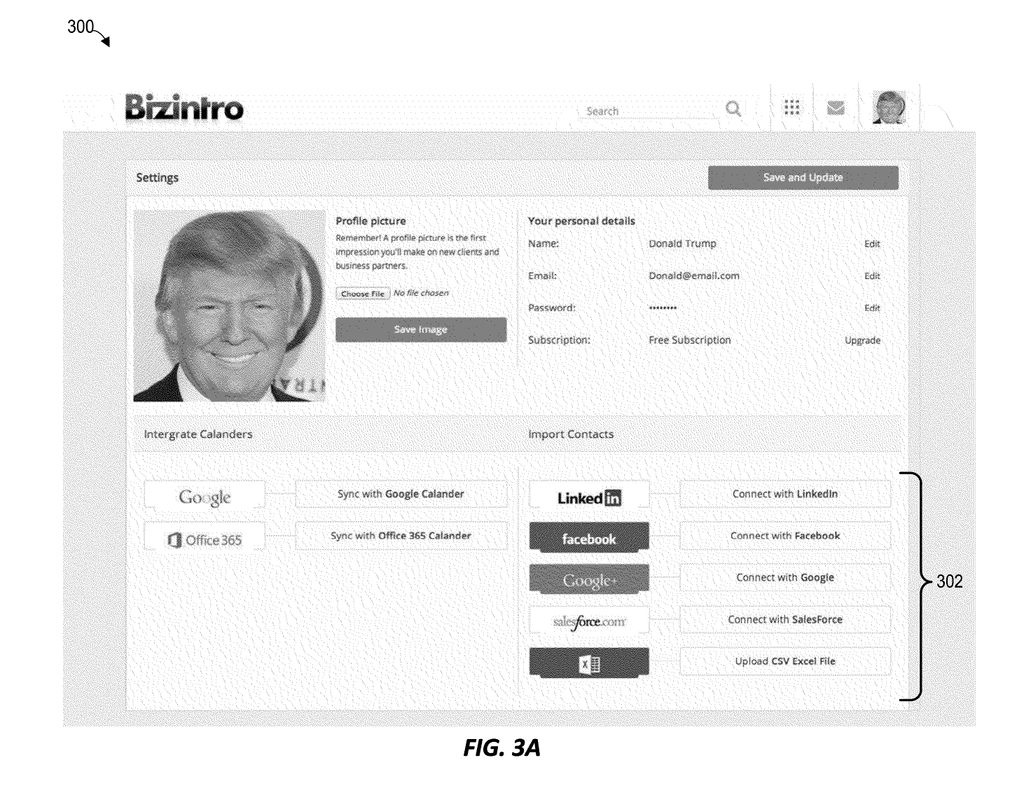

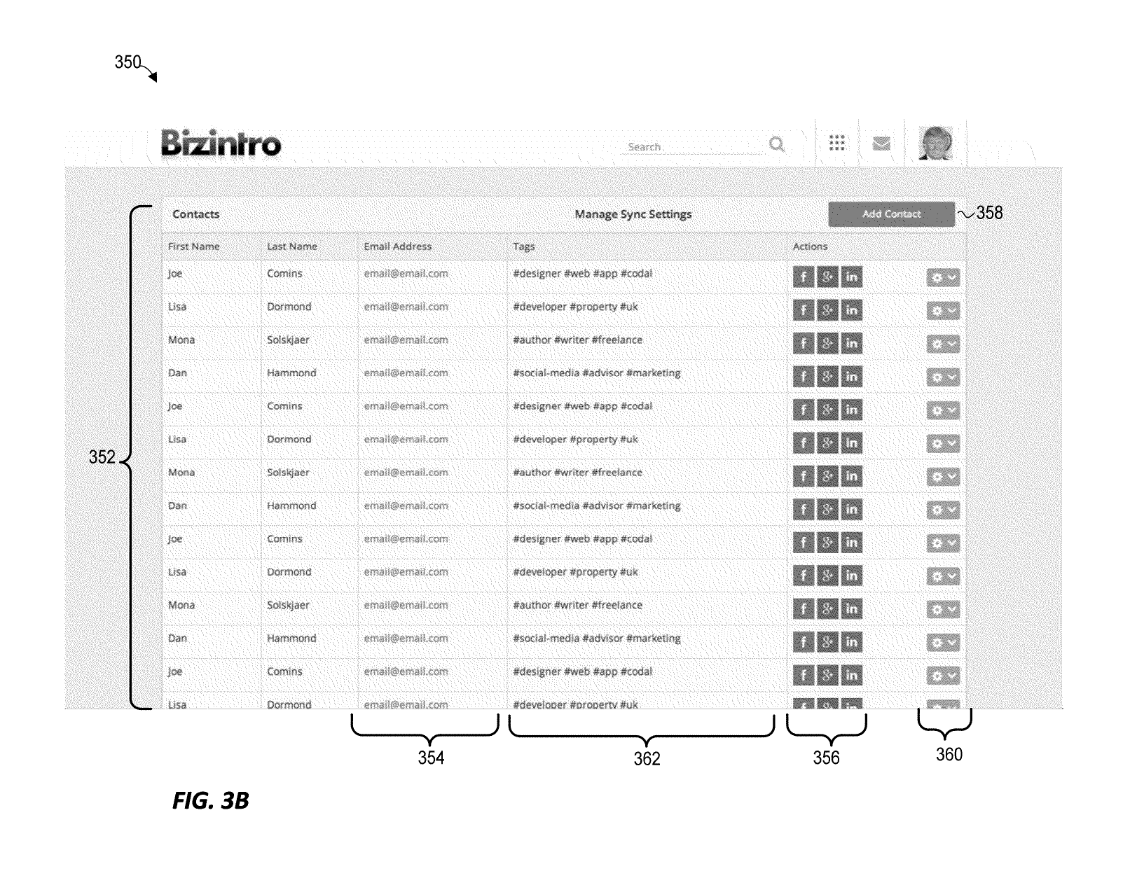

As illustrated in FIG. 3A, a user may access (e.g., via a web browser) an example web page 300 (e.g., with content generated by the business introduction server 108) to retrieve and/or upload business contacts.

In one implementation, the web page 300 may include one or more selectable (e.g., via a click or tap) links 302 allowing the user to “connect to” various third party networking, email, or other service so as to import contacts stored by those third party services. For example, a user may click on one of the links 302 to import contacts from a third party email service. Subsequently, the user may be redirected to a web page generated by the third party site, prompted to provide proper authentication information, etc. Once the user authenticates their identify to the third party service, the service may provide the business introduction server 108 with data (e.g., names, titles, emails, etc.) about business contacts of the user or may provide the business introduction server 108 with necessary information/data so as to retrieve data about the business contacts upon request.

Generally, a user may import contacts to the business introduction server 108, or to a database, such as the user database 112, from any number (one, two, three, etc.) of third party services. For example, the user may import contacts from email services (e.g., Gmail, Hotmail, Yahoo Mail, etc.), social media sites (e.g., Google+, Facebook, Twitter, etc.), professional networking sites (e.g., Yammer™, LinkedIn®, etc.), customer relationship management (CRM) services (Salesforce, SugarCRM, etc.), or any other services utilized to record, track, update, and/or manage business contacts. Further, a user may upload data stored by the user locally (e.g., stored on the end user device 102) or remotely (e.g., on a cloud based storage service) about business contacts. For example, a user may store data about business contacts locally in a spreadsheet, email client, or other format, such as a Microsoft Excel spreadsheet. As such, the user may choose (e.g., by selecting one of the links 302) to upload a file (e.g., a Microsoft Excel Spreadsheet) or provide access information (hyperlink, authentication, etc.) to a file stored on a remote storage.

The data about business contacts imported by the user may include various types of information, and the various sources of the data about business contacts (e.g., Linkedin, Google+, etc.) may store differing types of information about business contacts. In some implementations, the business introduction server 108 may store any and all types of information about business contacts from third party services. For example, the business introduction server 108 may store names, titles, and phone numbers for some business contacts imported from a CRM service, whereas the business introduction server 108 may store names and email addresses for business contacts imported from an email service. In other implementations, the business introduction server 108 may be configured to import business contact information of only a number of pre-defined types. For example, the business introduction server 108 may extract certain “fields” from data imported from third party services, such as name, address, phone number, email address, title, employer, etc. If the third party service, from which data about business contacts is retrieved, does not provide certain of these fields, the business introduction server 108 may populate the fields available and leave unavailable fields blank or unpopulated.

In some scenarios, data from multiple third party services (e.g., imported via the web page 300) may include data about the same business contacts. For example, a professional networking site may provide data about a “John Smith, VP of Engineering” and an email service may also provide data about a “John Smith, Vice President of Engineering, jsmith@company.com.” In such scenarios, the business introduction server 108 may execute the business introduction tool program 160, for example, to analyze the data from multiple sources (e.g., the professional networking site and the email service) to identify common business contacts, so as to not create duplicate records of business contacts. For example, the business introduction tool program 160 may analyze the entries such as “John Smith,” “J. Smith,” etc. and “VP of Engineering,” “Vice President,” etc. to recognize common business contacts. Generally the business introduction tool program 160 may utilize any suitable text-based analysis techniques (e.g., using correspondences based on signatures, grammars, etc.) or other algorithms to deduce commonalties, deviations, and/or contradictions between data provided by multiple third party service and/or uploaded data from an end user.

Data retrieved from multiple sources (e.g., a user generated spreadsheet and a third party email service) that corresponds to the same business contact may, in many cases, contain contradictions. For example, a user generated spreadsheet may include a certain name, title, employer, phone number, and email address corresponding to a business contact and an email service may include the same name, title, employer, and phone number, but a different email address. In such cases, the business introduction server 108 may “cross-reference” the data from multiple sources so as to generate an up-to-date, information rich, and accurate repository of business contact information.

Specifically, the business introduction server 108 may identify, as discussed above, and correct contradictions between data about business contacts from multiple sources. For example, in the scenario discussed above in which two data sources indicates two email addresses for the same business contact, the business introduction server may (i) record both email addresses in a database of business contacts and associate both email addresses with the business contact, or (ii) record only one of the email addresses using a rules-based or other type of algorithm. In one example, the business introduction server 108 may recognize that the two email addresses are a personal email address and a business email address (e.g., based on the host names in the email addresses). In this example, the business introduction server 108 may record both email addresses associated with the business contact. On the other hand, one of the email addresses may be out-of-date. To mediate such inconsistencies, the business introduction server 108 may store or generate a priority list which prioritizes certain sources of data above other sources of data. For example, when “importing” contacts via the web page 300, the user may indicate which data sources are to be prioritized based on the user's knowledge of the accuracy of the sources. Alternatively, the business introduction server 108 may store a pre-defined prioritization of types of sources (e.g., a professional networking site over a social media site).

Also, the business introduction server 108 may cross-reference multiple sources of data to generate and store a more informative record corresponding to a business contact than can be generated by any one of the multiple sources of data. For example, for a certain business contact, an email service may provide a name and an email address, while a CRM service may provide a name, employer, title, and phone number, and a social media site may provide a name and a social media username (e.g., a Twitter username). In this example, the business introduction server may generate and store a record for the business contact including a name, email address, employer, title, phone number, and social media username. This record includes more information than is available via any one of the individual sources of data, and, as such, a user of the business introduction interface, as discussed below, may utilize the business introduction interface as, among other things, the most up-to-date and information rich repository of business contact information.

In some implementation, users of the business introduction interface (e.g., user of the end user device 102) may retrieve or upload business contact data to the business introduction server 108 as part of their normal workflow via a plug-in, add-on, bookmarklet, or other software component cooperating with one or more applications executed by the end user device 102. For example, a user may retrieve a plug-in, add-on, bookmarklet, or other software component from the business introduction server 108 or other suitable remote server, such as a server managing a “store” for applications, and “install” the software component on the end user device 102. Subsequently, the user may utilize the plug-in, add-on, bookmarklet, or other software component to retrieve data about business contacts and upload the data to the business introduction server 108.

In one scenario, a user may install a bookmarklet software component associated with the business introduction interface. During their normal workflow, or at any other suitable time, the user may use the bookmarklet to extract, “scrap,” or otherwise retrieve any pieces of information about a business contact viewed on the end user device 102. For example, the user may be browsing a website of a certain company and run across a business contact that the user would like to be imported into the business introduction interface. At such a time, the user may select (e.g., by highlighting) the text information about the business contact and indicate (e.g., by a mouse click, selection of a button, etc.) that the data is to be imported to the business introduction interface (e.g., sent to the business introduction server 108). The business introduction server 108 may receive the “scraped” information, cross-reference the information as discussed above, and add/modify a record corresponding to the business contact. Likewise, as discussed further below, a user may utilize the bookmarklet or other software component to automatically request an introduction to the business contact or from the business contact.

Now referring to FIG. 3B, a user may access, via web pages generated by the business introduction server 108, an example web page 350 including a list 352 of all business contacts aggregated, cross-referenced, and stored or linked by the business introduction server 108. The list 352 may include an indication (e.g., a text representation) of all of the “fields” (e.g., name, email, etc.) stored for each of the business contacts, or only a certain number of fields. Further, the list may include selectable (e.g., via a click or tap) links, such as one or more links 354 to email the business contacts and one or more links 356 to visit social network, professional network, or other external web page corresponding to a business contact. The user may also, via the web page 350, manually add a new contact (such as by using a keyboard to enter data corresponding to a business contact) via the button 358, modify data about the business contact via the buttons 360, or view further data about the business contacts (e.g., by clicking on one of the rows of the list 352).

The list 352, which may indicate information about the business contacts that is stored in the user database 112, may also include indications of one or more “tags” associated with the business contacts. The tags may be manually defined by users (e.g., via an interface prompted by selecting one of the buttons 360), or the tags may be automatically generated based on data imported from one or more third party services or uploaded data files. The tags may include any suitable keyword or terms which may distinguish the respective business contacts from one another, such as titles, company names, industry terms, specialties, etc. As discussed further below, these tags, along with any other data associated with each of the business contacts, may be utilized by the business introduction server 108 to filter business contacts for the requesting or completion of business introductions.

### Requesting Introductions

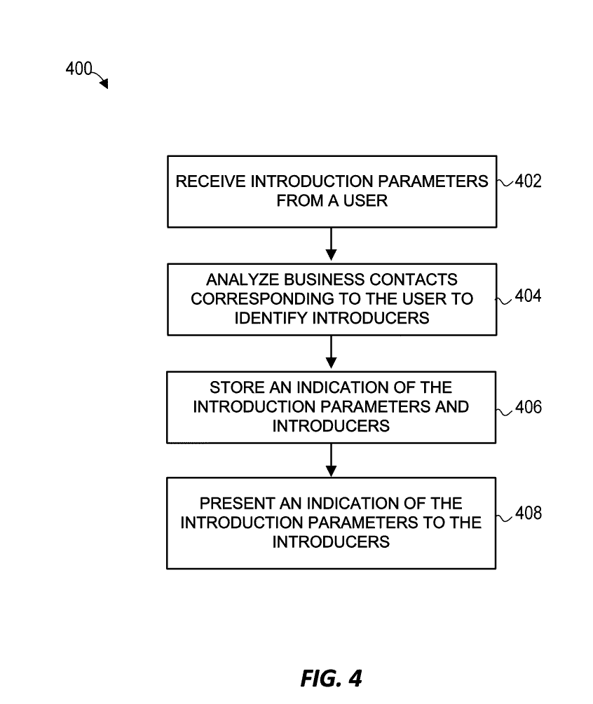

FIG. 4 is a flow diagram of an example method 300 for facilitating the requesting of business introductions. The method 300 may be implemented by the business introduction server 108, for example.

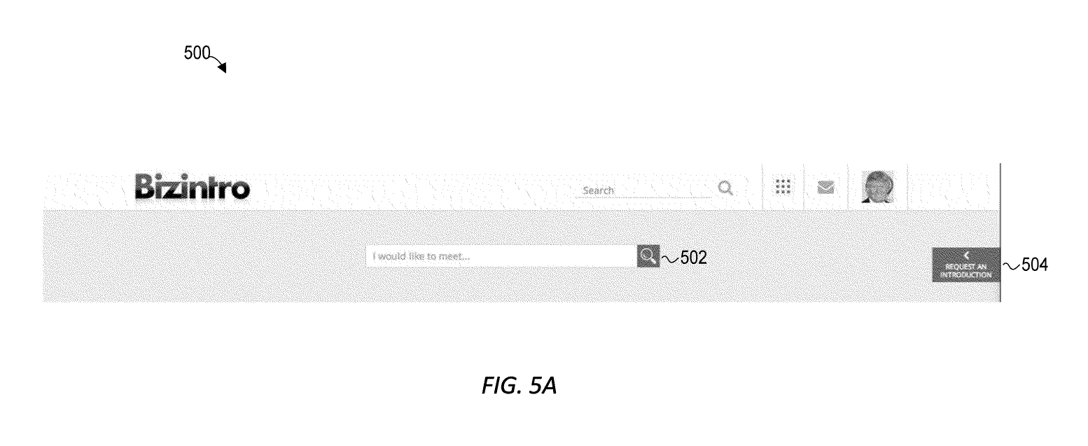

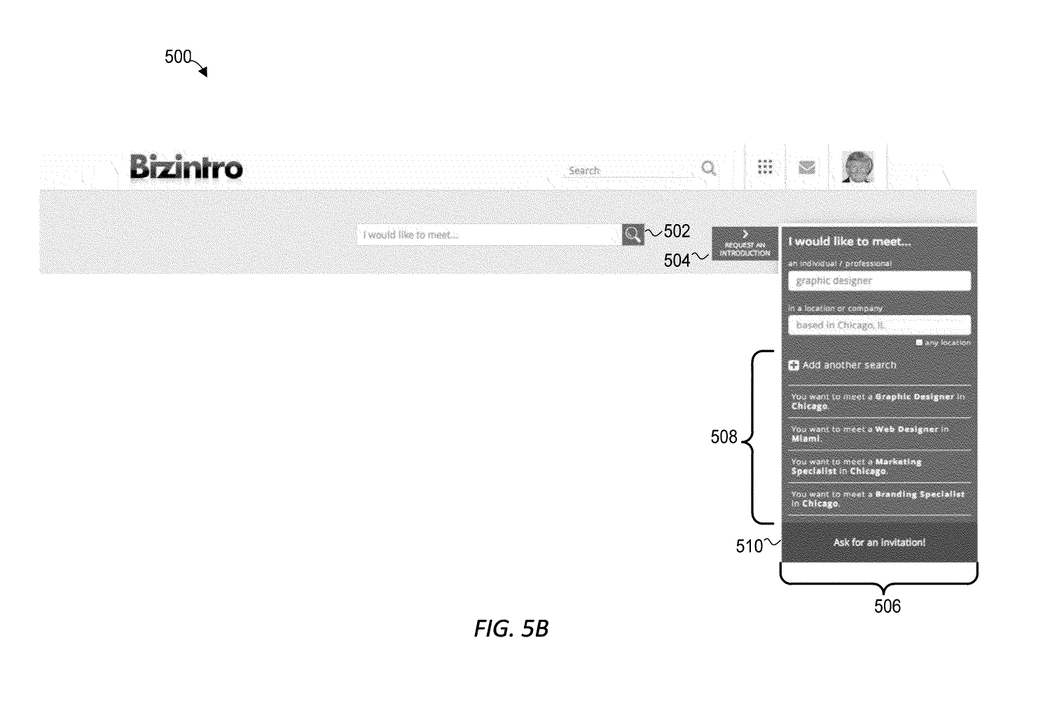

To begin, introduction parameters are received from a user (block 402). For example, a user may enter and communicate introduction parameters via a web page, such as the example web page 500 illustrated in FIGS. 5A and 5B. Upon navigating to the web page 500, the user may interact with the search bar 502 or the request tab 504. The user may enter keywords representative of a person, to whom they would like an introduction, into the search bar 502 and press a keyboard button to execute a search. The keywords may, for example, be “Graphic Designer Chicago” if the user would like to be introduced to a graphic designer in Chicago, Ill. The keywords may be sent to the business introduction server as the introduction parameters.

Alternatively, the user may select the request tab 504. Upon selection, the user may be presented with the request interface 506, as illustrated in FIG. 5B. In the interface 506, the user may enter keywords in multiple fields corresponding to multiple categories of introduction parameters, such as title, geographic location, company, etc. Also, the request interface 506 may indicate to the user recently requested introductions in the area 508. Upon clicking a button 510, the user may submit the introduction parameters to the business introduction server 108.

Next, business contacts are analyzed to identify potential introducers (block 404). For example, the business introduction server 108 may analyze the business contacts of the user to identify business contacts that are connected with (i.e., has business contacts themselves) individuals matching the introduction parameters. For example, if the user provides “Graphic Designer” and “Chicago” as introduction parameters (e.g., via the request interface 506), the business introduction server 108 may determine which of the business contacts corresponding to the user has a contact of their own that is a graphic designer in Chicago, Ill. In other words, the business introduction server 108 analyzes the contacts of the user's business contacts, or “second” level/degree connections, to identify contacts of the user from whom they might receive the requested introduction.

In the scenario in which the user utilizes the search bar 502 to input introduction parameters, the user may be presented with a list of business contacts from whom they might receive the requested introduction. For example, they might be presented with a list of a subset of their business contacts, where the subset of business contacts each “know” (i.e., have a business contact of their own) that matches the introduction parameters. The user may select one or more of the subset of business contacts (e.g., with a click or tap) so as to define “introducers” from whom they would like to receive an introduction. Otherwise, such as in the case of the utilization of the request interface 506, the business introduction server 108 may identify all of the subset of business contacts as introducers.

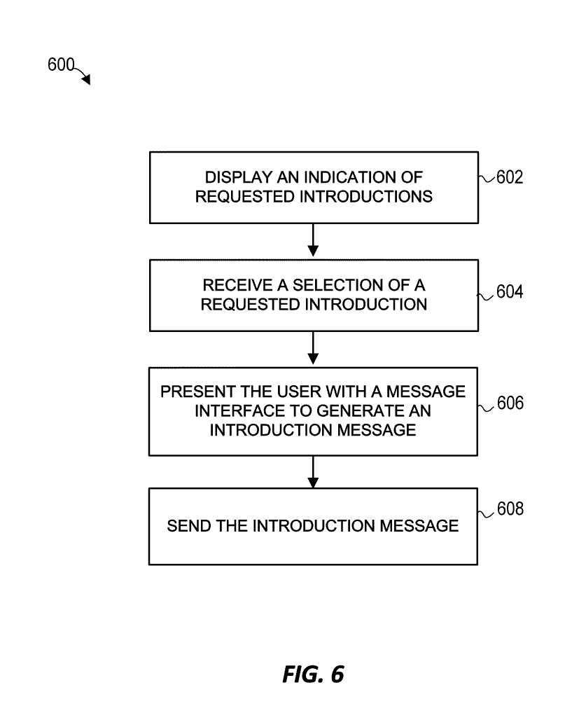

An indication of the introduction parameters and the introducers is then stored (block 406). For example, the business introduction server 108 may store an indication of the introduction parameters and the introducers in the user database 112 as an indication of the requested introduction corresponding to the user. Subsequently, when the introducers access the business introduction interface, the introducers may be presented with an indication of the requested introduction, such as “Bob Smith would like an introduction to a graphic designer in Chicago, Ill.,” as further discussed with reference to FIG. 6. Alternatively or additionally, the business introduction server 108 may actively send a communication (e.g., email message, text message, mobile alert, etc.) to the introducers to solicit the requested introduction.

Generally, the business introduction server 108 may utilize any text-based or other matching and/or search algorithms to filter business contacts based on the introduction parameters. Such algorithms may include keyword matching algorithms, fuzzy logic algorithms, probability based algorithms, etc. For example, the business introduction server 108 may utilize some or all of the filtering techniques discussed in U.S. patent application Ser. No. 14/052,480, filed Oct. 11, 2013, and entitled “BUSINESS INTRODUCTION TOOL,” the disclosure of which is hereby expressly incorporated by reference herein.

### Making Introductions

FIG. 6 is a flow diagram of an example method 600 for facilitating the making of effective business introductions. The business introduction server 108 may implement the method 600, for example.

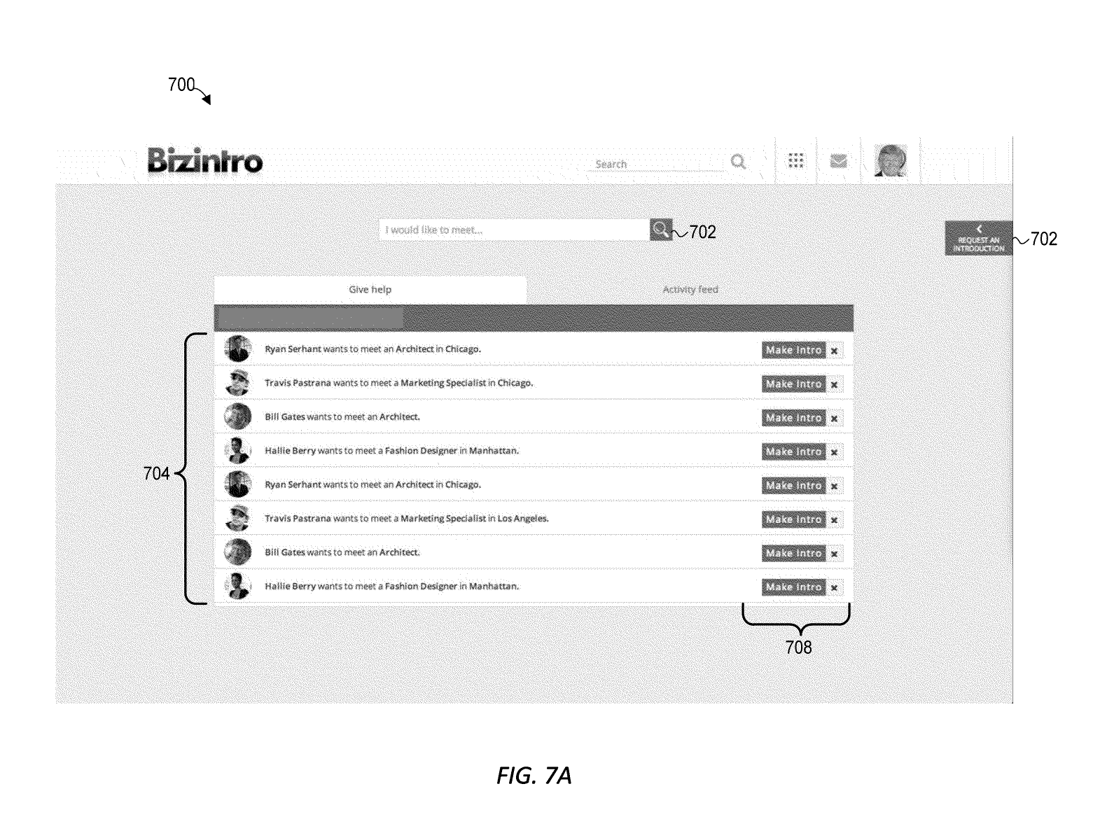

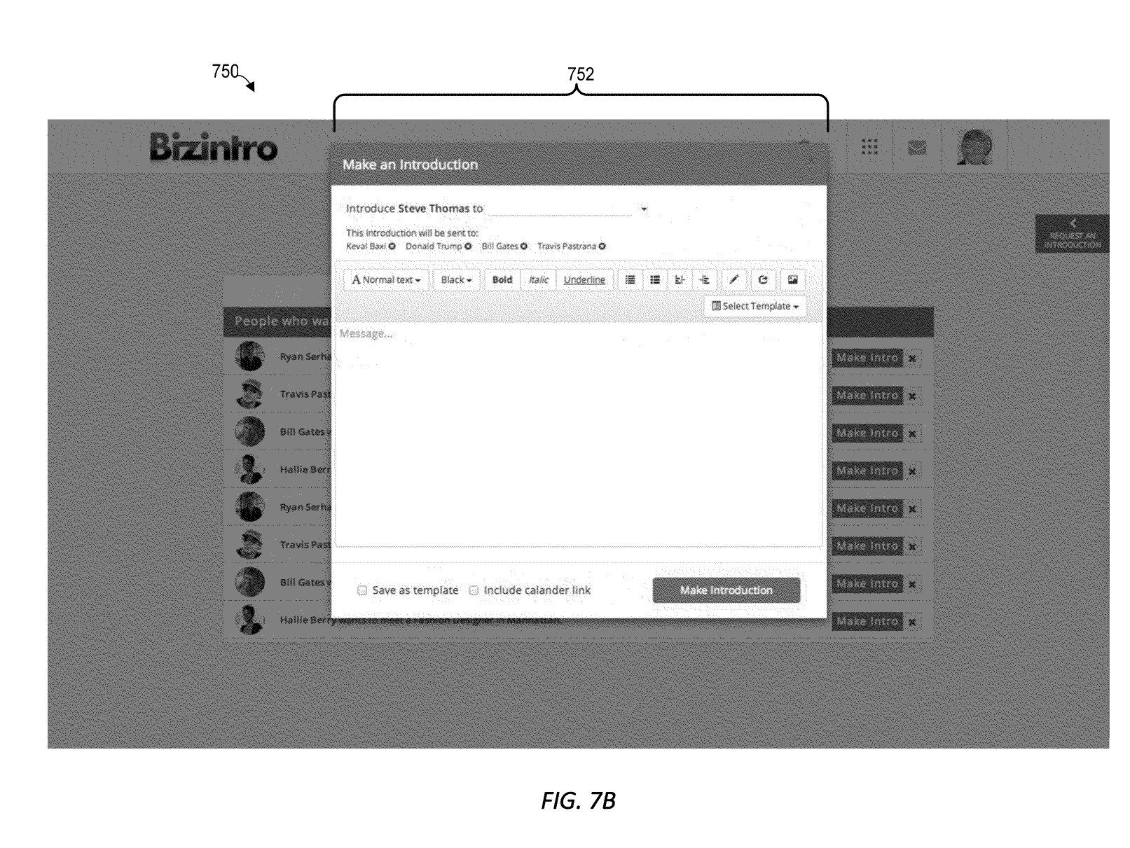

To begin, an indication of requested introduction is displayed to a user (block 602). For example, a user may navigate to an example web page 700 as illustrated in FIG. 7A, such as a “home page” of a business introduction interface generated by the business introduction server 108. Along with selectable links 702 which may allow the user to request introductions, the user may be presented with a list 704 of requested introductions from some of their business contacts. That is the list 704 indicates requested introductions (e.g., by text descriptions and/or introduction parameters) that may be made by the user on behalf of some of their business contacts.

In some implementations, the business introduction server 108 may generate the list 704 by analyzing data in the user database 112 including stored introduction parameters (“graphics design” and “Chicago”). For example, the business introduction server 108 may identify requested introductions in which the user is defined as an introducer, as further discussed with reference to FIG. 4. The business introduction server 108 may generate the list 704 including all of the introductions requested of the user by their business contacts, or at least a certain number of the introductions requested of the user. The list 704 may include text descriptions of the requested introductions (e.g., generated from the introduction parameters) and an indication of who requested the introduction (e.g., a name of a business contact).

Each of the indications of the requested introductions in the list 704 may include one or more interactive/selectable elements 708 allowing the user to complete the requested introductions, view further information about the introduction, or complete any other actions related to the requested introduction. Further, in some implementations, the user may be presented with a filtered list of their contacts matching the introduction parameters of a certain requested introduction, when the user “hovers” a mouse over or selects one of the requested introductions in the list 708. For example, if a requested introduction has parameters “graphics designer” and “Chicago,” upon hovering over the requested introduction, the user may be presented with an indication of all of their business contacts that are graphics designers in Chicago, Ill. Also, a user may be presented with such a filtered list upon selection of one of the elements 708. In some implementations, the user is only presented with an indication of a requested introduction if the user has at least one business contact matching the introduction parameters of the requested introduction.

Returning to FIG. 6, a selection of a specific introduction is received (block 604). For example, the user may hover over one of the requested introduction in the list 704 and select a particular business contact from a filtered list of business contacts, or the user may select one of the elements 708 and subsequently select a particular business contact from a filtered list of business contacts. In this manner, a user may select a particular business contact to which the user will introduce the requester of the introduction.

Next, a user is presented with a message interface to generate an introduction message (block 606). FIG. 7B is an example web page 750 including a message interface 752. The message interface 752 may, in many ways, resemble an email message interface and may allow the user to type a personalize introduction message introducing the selected one of the filtered business contacts to the requester of the business introduction. In an implementation, the message interface 752 may include a blank message body allowing the use to type a completely new introduction message. However, in some implementations, the business introduction server 108 and message interface 752 may utilize message templates, substitutive variables, and other messaging functionality as described in U.S. patent application Ser. No. 14/052,480, filed Oct. 11, 2013, and entitled “BUSINESS INTRODUCTION TOOL.” In particular, the user may be presented with customizable and automatically generated message templates to ease the process of making business introductions.

When the user has completed the business introduction message via the message interface 752, the introduction message is sent to the selected one of the filtered business contacts. The introduction message may be sent as an email message, text message (e.g., SMS), mobile alert (e.g., PUSH alert), automated phone call, or any other suitable communication based on the generated introduction message.

### Integrated Interface Components

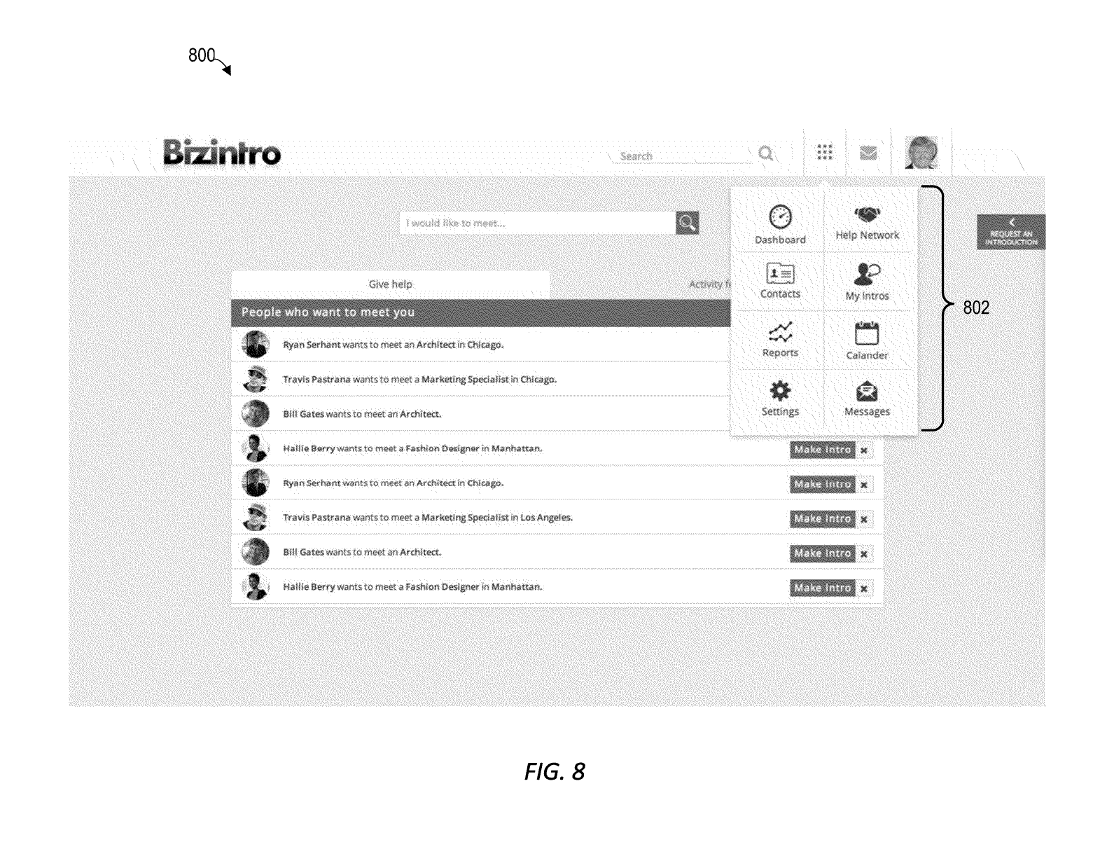

FIGS. 8, 9, 10, and 11 illustrate additional components that may be integrated into a business introduction interface (e.g., via content generated by the business introduction server 108). For example, the components illustrated in FIGS. 8, 9, 10, and 11 may be part of a business introduction web portal or online tool utilized to manage business introductions, appointments, communications, etc. along with requesting and making introductions (e.g., via the web pages illustrated in FIGS. 5A, 5B, 7A, and 7B).

FIG. 8 is an example web page 800, which may be implemented along with components illustrated in FIGS. 5A, 5B, 7A, and 7B, with an expandable navigation window 802 allowing a user to navigate within the business introduction tool. For example, by selecting (e.g., with a click or tap) the various areas of the navigation window 802 a user may view a requested introduction, messages from business contacts, a calendar interface with upcoming introduction appointments, current setting/preferences of the business introduction interface, etc.

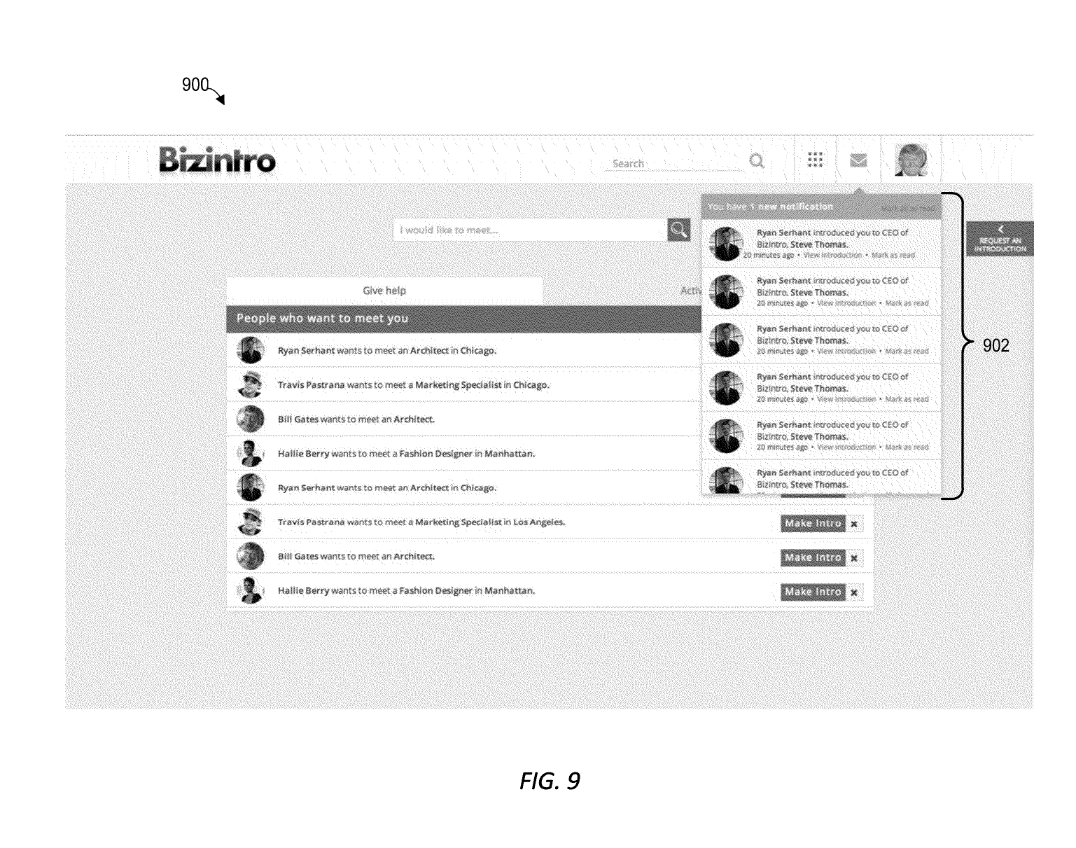

FIG. 9 is an example web page 900 including an expandable notification window 902 which may be implemented along with web page components discussed with reference to FIGS. 5A, 5B, 7A, 7B, and 8. The notification window 902 may include an up-to-date (e.g., in near real time) feed of introductions that have been made of the behalf of the user, introduction made by the user, and other alerts (e.g., newly added contacts, errors, etc.). In this manner, a user may quickly see recent actions taken by the user of the user's business contacts within the business introduction interface.

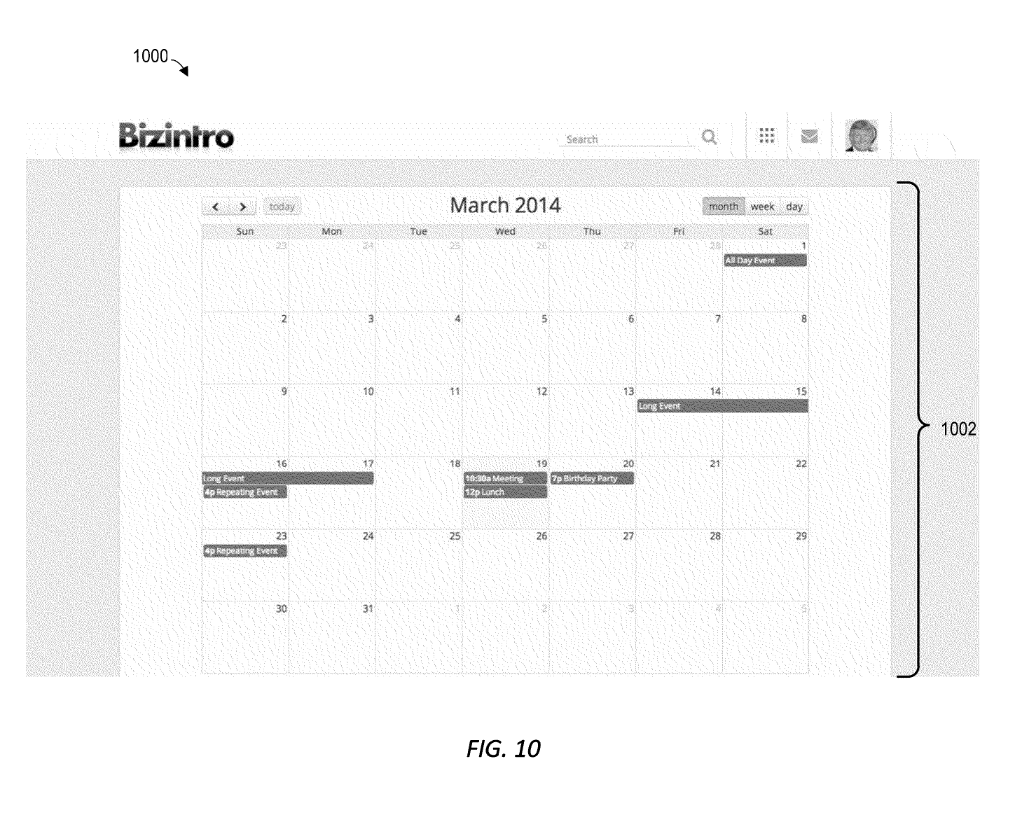

FIG. 10 is an example web page 1000 including a calendar interface 1002 which may be navigated to via the navigation window 802, for example. The calendar interface 1002 may include indications (times, dates, details, notes, etc.) of appointments made with business contacts or those to whom to user has been introduced via the business introduction interface. Moreover, the calendar 1002 may be “synced” with third party calendar services so as to display consistently configured calendars in the business introduction interface and the third party services. For example, the user may connect (e.g., provide data relevant to, authentication information, etc.) the business introduction server 108 to a third party calendar service via the web page 300. The calendar interface 1002 may implement this functionality and other functionality as described further in U.S. patent application Ser. No. 14/052,480, filed Oct. 11, 2013, and entitled “BUSINESS INTRODUCTION TOOL.”

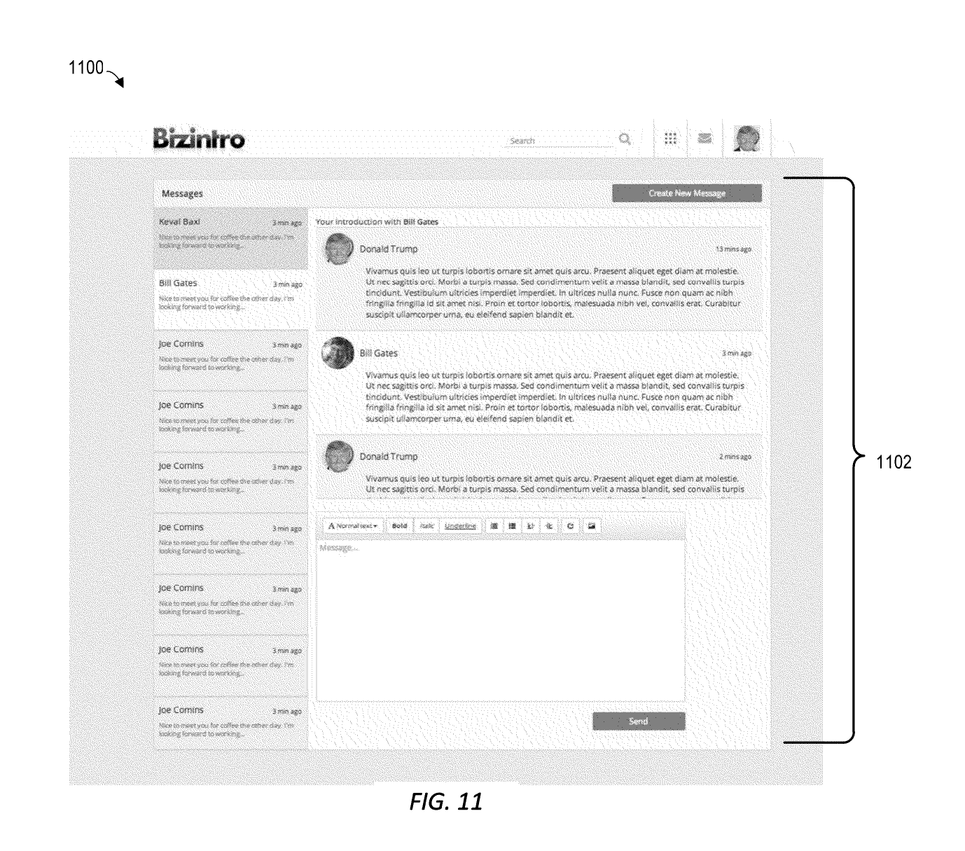

FIG. 11 is an example web page 1100 including a messaging interface 1102 which may be navigated to via the navigation window 802, for example. The messaging interface 1102 may allow a user to view introduction message previously sent, follow up with recipients of introduction messages, send direct messages to business contacts, etc. The user may create new messages, reply to messages, delete messages, organize messages into folders, etc. via the messaging interface 1102. In this manner, the user may track recent introductions, arrange introduction meeting, etc. seamlessly within the business introduction interface without having to exit the interface to interact with an external email client or service, for example.

What is claimed:

1. A computer-implemented method comprising:
receiving, via one or more processors, introduction parameters from a user of a website, wherein the introduction parameters comprise keywords describing a type of person to which the user would like to be introduced;
analyzing, by the one or more processors, business contacts corresponding to the user to identify a set of introducers, wherein the set of introducers comprises a subset of the business contacts having their own respective business contacts matching the introduction parameters;
storing, by the one or more processors, the introduction request, wherein storing the introduction request comprises storing the introduction parameters and the set of introducers; and
presenting, by the one or more processors, an indication of the introduction parameters to each of the set of introducers.

2. The computer-implemented method of claim 1, wherein receiving the introduction parameters further comprises:
generating, by the one or more processors, a graphical user interface (GUI), wherein the generated GUI is displayed on an end user device associated with the user; and
receiving, via the GUI, inputs from the user indicating the introduction parameters.

3. The computer-implemented method of claim 2, wherein receiving the inputs from the user further comprises:
receiving, via the GUI, at least one of text entered into a search bar or a selection of a recently requested introduction.

4. The computer-implemented method of claim 3, wherein the receiving the text entered into a search bar further comprises:
receiving, via the GUI, text entered into multiple search fields, wherein the multiple search fields correspond to respective categories of introduction parameters, and wherein the categories of introduction parameters comprise at least one of: a title, a geographic location, or a company.

5. The computer implemented method of claim 1, wherein presenting the indication of the introduction parameters further comprises:
for each of the set of introducers, performing, by the one or more processors, at least one of:
transmitting, via the one or more processors, an active communication to the introducer, wherein the active communication comprises at least of an email, a text message, or a mobile alert, and
presenting, on a GUI displayed on an end user associated with the introducer, an indication that the user is seeking the transmitted introduction.

6. A computer-implemented method comprising:
displaying, on a graphical user interface (GUI), an indication that a user has received a plurality of introduction requests;
receiving, via the GUI, a selection of a specific introduction request from the plurality of introduction requests;
presenting, on the GUI, a message interface, wherein the message interface enables the user to generate an introduction message to a business contact in accordance with the specific introduction request; and
sending, via one or more processors, the introduction message to the business contact.

7. The computer-implemented method of claim 6, wherein displaying the indication that a user has received a plurality of introduction requests further comprises:
displaying, on the GUI, a list of requested introductions,
wherein the list of requested introductions comprises a list of business contacts and corresponding introduction parameters, and
wherein the introduction parameters comprise keywords describing a type of person to which the business contact would like to be introduced.

8. The computer-implemented method of claim 7, wherein displaying the list of requested introductions further comprises:
querying, via the one or more processors, a database of stored introduction requests; and
generating, via the one or more processors, a list of introduction requests in the database corresponding to introduction requests from a business contact,
wherein the introduction request requests an introduction to be made by the user, and
wherein the list of introduction requests only includes introduction requests in which a business contact of the user matches the introduction parameters corresponding to the respective introduction request.

9. The computer-implemented method of claim 7, wherein receiving the selection of the specific introduction request further comprises:
displaying, on the GUI, a selectable element corresponding to each entry in the list of requested introductions; and
receiving, via the GUI, a selection of the selectable element corresponding to the specific introduction request.

10. The computer-implemented method of claim 6, further comprising:
in response to receiving the selection of the specific introduction request, displaying, on the GUI, a filtered list of business contacts, wherein the filtered list of business contacts comprises business contacts of the user that match introduction parameters corresponding to the introduction request; and
receiving, via the GUI, a selection of a particular business contact from the list of filtered business contacts.

11. The computer-implemented method of claim 10, wherein presenting the message interface further comprises:
presenting, on the GUI, a customizable template message to transmit to the particular business contact.

12. The computer-implemented method of claim 10, wherein sending the introduction message further comprises:
sending, via the one or more processors, the generated introduction message to the particular business contact, wherein the generated introduction message comprises at least one of an email, a text message, a mobile alert, or an automated phone call.
